(19) United States
(12) Patent Application Publication
(10) Pub. No.: US 2016/0379313 A1
(43) Pub. Date: Dec. 29, 2016

(54) IDENTIFICATION OF EMPLOYEES ON EXTERNAL SOCIAL MEDIA

(71) Applicant: International Business Machines Corporation, Armonk, NY (US)

(72) Inventors: Casey Dugan, Cambridge, MA (US); Werner Geyer, Newton, MA (US); Stela Lupushor, Summit, NJ (US); Jamie C. Rasmussen, Somerville, MA (US); Tristan J. Ratchford, Boston, MA (US); N. Sadat Shami, Scarsdale, NY (US)

(21) Appl. No.: 14/748,284

(22) Filed: Jun. 24, 2015

(51) Int. Cl. G06Q 50/00; G06Q 10/10

(52) U.S. Cl. CPC G06Q 50/01; G06Q 10/105

(57) ABSTRACT

A method for identifying employees across external social media sites including generating a list of at least one external social media site to be compared with an enterprise directory, comparing a plurality of users in the at least one external social media site to at least one employee in the enterprise directory, and determining a match between the at least one employee in the enterprise directory and at least one user in the at least one external social media site.

### BACKGROUND

The present invention generally relates to the field of social networking using a computer on a communication network, and more particularly to identifying employees on external social media sites.

Social media may be defined as a group of internet-based applications that may allow the creation and exchange of user-generated content. Currently, social media applications may provide a mean by which organizations, communities and individuals interact by creating, sharing, discussing, exchanging and commenting on content in virtual communities and networks. Virtual communities may be in the form of a group of people who are closely linked in a social network, or those who share common interests, but do not necessarily interact directly with each other. Upon joining a social network, a member may create a digital persona, which may be expressed as a profile, where the member's various likes and interests can be listed, such as politics, movies, books, religious affiliations, sports, and professional associations. Either for personal use or business use, social media has become a ubiquitous tool for daily social communication. Popular social media sites may include internet websites such as Facebook® (Facebook and all Facebook-based trademarks and logos are trademarks or registered trademarks of Facebook and/or its affiliates, LinkedIn® (LinkedIn and all LinkedIn-based trademarks and logos are trademarks or registered trademarks of LinkedIn and/or its affiliates and Twitter® (Twitter and all Twitter-based trademarks and logos are trademarks or registered trademarks of Twitter and/or its affiliates).

### SUMMARY

According to an embodiment of the present disclosure, a method for identifying employees across external social media sites may include generating a list of at least one external social media site to be compared with an enterprise directory, comparing a plurality of users in the at least one external social media site to at least one employee in the enterprise directory, and determining a match between the at least one employee in the enterprise directory and at least one user in the at least one external social media site.

According to another embodiment of the present disclosure, a computer system for identifying employees across external social media sites may include one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method including generating a list of at least one external social media site to be compared with an enterprise directory, comparing a plurality of users in the at least one external social media site to at least one employee in the enterprise directory, and determining a match between the at least one employee in the enterprise directory and at least one user in the at least one external social media site.

According to another embodiment of the present disclosure, a computer program product for identifying employees across external social media sites may include a computer readable non-transitory article of manufacture tangibly embodying computer readable instructions which, when executed, cause a computer to carry out a method including generating a list of at least one external social media site to be compared with an enterprise directory, comparing a plurality of users in the at least one external social media site to at least one employee in the enterprise directory, and determining a match between the at least one employee in the enterprise directory and at least one user in the at least one external social media site.

### BRIEF DESCRIPTION OF THE SEVERAL VIEWS OF THE DRAWINGS

The following detailed description, given by way of example and not intended to limit the invention solely thereto, will best be appreciated in conjunction with the accompanying drawings, in which:

FIG. 1 is a block diagram illustrating a networked computer environment, according to an embodiment of the present disclosure;

FIG. 2 illustrates a networked computer environment with an exemplary comparison program to map employees to external social media accounts, according to an embodiment of the present disclosure;

FIG. 3 is a block diagram of internal and external components of computers and servers depicted in FIG. 1, according to an embodiment of the present disclosure;

FIG. 4 is a block diagram of an illustrative cloud computing environment including the computer system depicted in FIG. 1, according to an embodiment of the present disclosure; and

FIG. 5 is a block diagram of functional layers of the illustrative cloud computing environment of FIG. 4, according to an embodiment of the present disclosure.

The drawings are not necessarily to scale. The drawings are merely schematic representations, not intended to portray specific parameters of the invention. The drawings are intended to depict only typical embodiments of the invention. In the drawings, like numbering represents like elements.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

Embodiments of the present invention generally relates to the field of social networking using a computer on a communication network, and more particularly to identifying employees on external social media sites. The following described exemplary embodiments provide a system, method and program product for mapping employees in a corporate network or directory to accounts on external social media sites.

As previously mentioned, either for personal or business use, social media has become a ubiquitous tool for daily social communication. Although the use of social media sites such as Facebook®, Twitter® or LinkedIn® may be advantageous in some respects, confidential or critical information for enterprises or businesses may be made public through these websites by employees either accidentally or deliberately. Therefore, it may be beneficial for an enterprise to monitor and understand the nature of the information shared by employees on different external social media sites, whether to prevent data leaks or simply to know their current point of view about topics of possible interest for the company.

Enterprises may typically have an internal directory of their employees, however it may be difficult to map a user of an external social media site to matching an internal employee identity. A few existing alternatives to accomplish this may include: 1) creating a space for employees to internally volunteer links or user names to their external identities, such as allowing them to list them on their corporate profiles; however, this relies on participation from each employee and may therefore suffer from lack of contribution, 2) creating lists or groups on the external social media sites for the enterprise in question (for example, the “IBMers” list on Twitter®), this solution may not provide the enterprise a competitive advantage in keeping that knowledge internal. Furthermore, this may not be in sync with the official corporate directory, not having the information to match specific employee identifying information (e.g. serial number) to account information on that external system as the external social media sites do not have access to company internal information.

Therefore, embodiments of the present disclosure may, among other potential benefits, pull a user account from external social media sites that may potentially be associated with an employee of a given enterprise, determine whether that external account truly belongs to the employee, keep track of those mapping of employees to external social media accounts and keep that information up to date with changes in the corporate directory. As such, the present embodiment has the capacity to improve the technical field of social media by enabling an enterprise to monitor information shared by employees on different external social media sites. More specifically, the present embodiment may assist an enterprise in preventing a potential data breach or leak of information in addition to discovering an employee's view about topics of possible interest for the company.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

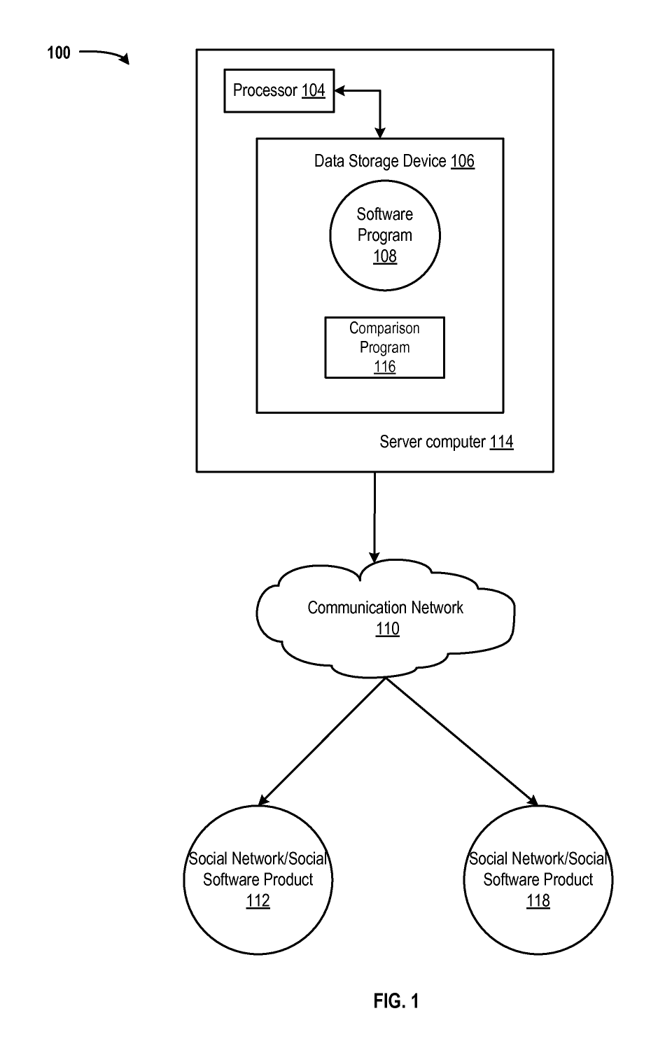

Referring to FIG. 1, an exemplary networked computer environment 100 in accordance with one embodiment is depicted. The networked computer environment 100 may include a server computer 114 with a processor 104 and a data storage device 106 that is enabled to run a software program 108 and a comparison program 116 which are able to connect to a social network provider, such as Twitter®, or Facebook®. The networked computer environment 100 may also include social network/social software product 112, social network/social software product 118, and a communication network 110. It should be noted that the networked computer environment 100 may include a plurality of server computers 114, only one of which is shown. The communication network 110 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

The server computer 114 may use the software program 108 to communicate with social networks/social software products 112, 118 (e.g. Twitter® or Facebook®). The social networks/social software products 112, 118 may be running on separate server computers (not shown) via the communication network 110. The server computer 114 may also use the comparison program 116 to interact with the social networks/ social software products 112, 118. More specifically, the comparison program 116 may include a mapping storage system able to communicate with the social networks/social software products 112, 118 to map employees to external social media accounts. The comparison program 116 may include any algorithm capable of establishing a match between a corporate and an external social media account by comparing certain profile information as will be described in detail below.

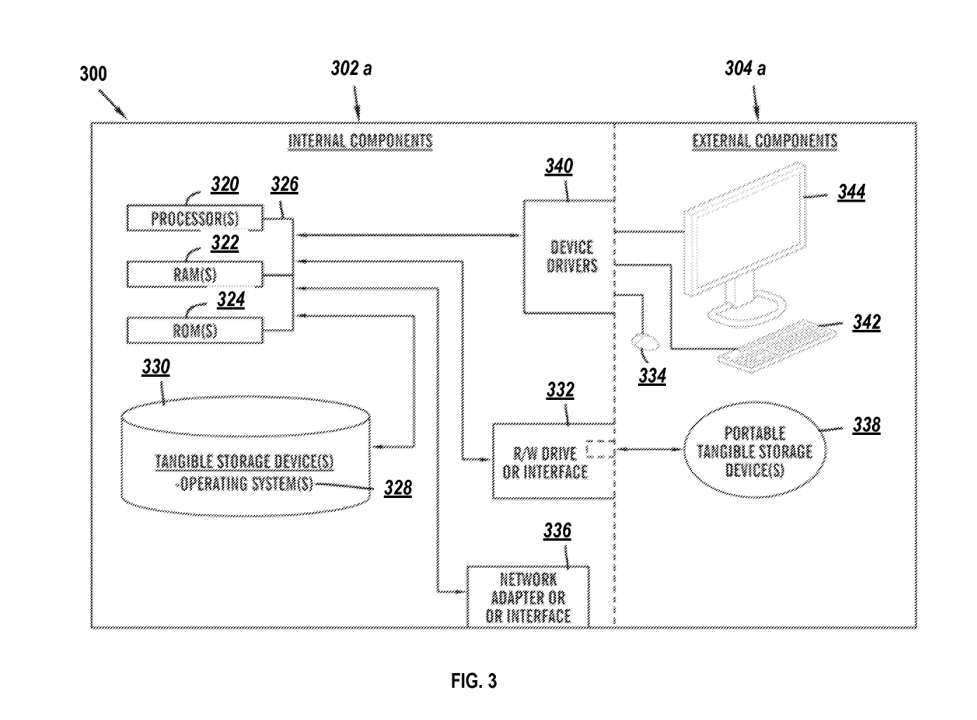

The communication network 110 may include connections, such as wire, wireless communication links, or fiber optic cables. As will be discussed with reference to FIG. 3, server computer 114 may include internal components 302 and external components 304, respectively. Server computer 114 may be, for example, a mobile device, a telephone, a personal digital assistant, a netbook, a laptop computer, a tablet computer, a desktop computer, or any type of computing devices capable of accessing a social network.

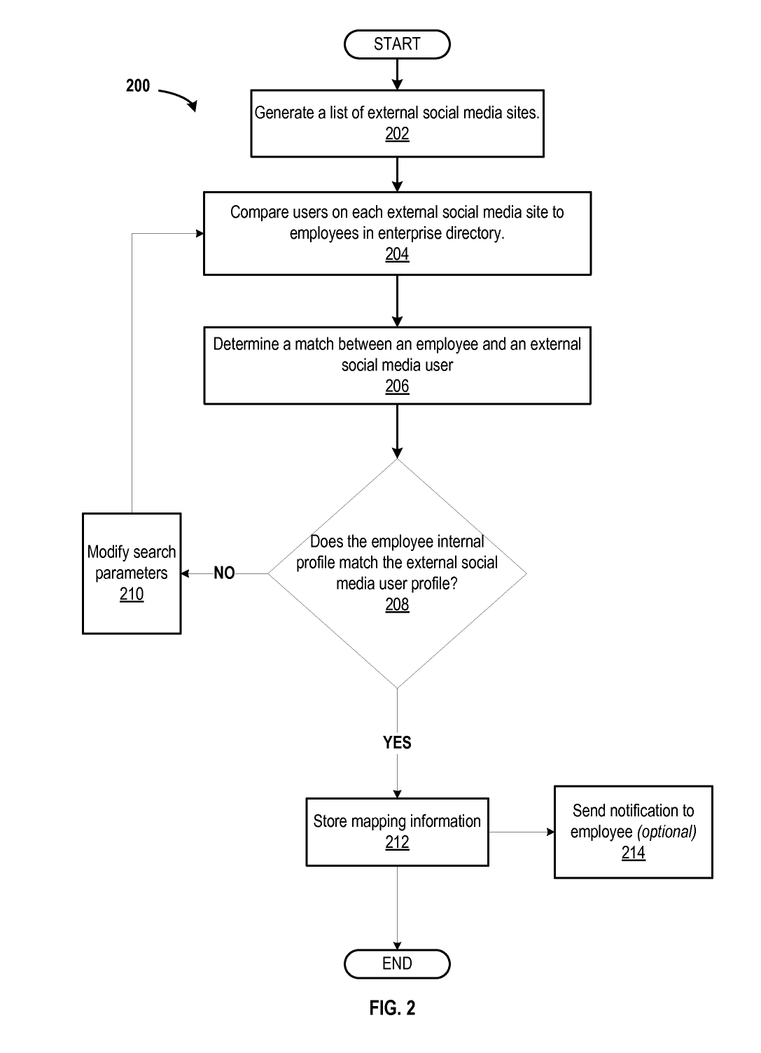

Referring now to FIG. 2, an operational flowchart 200 illustrating the steps carried out by the comparison program 116 (FIG. 1) to identify an employee across external social media sites (e.g. social networks/social software products 112, 118) is shown, according to an embodiment of the present disclosure. At 202, a list of external social media sites or social network services whose users may be compared with the corporate directory may be generated or can be accessed by the computer generation of new and upcoming social media websites. It should be noted that the comparison program 116 (FIG. 1) may be capable of automatically generating the list of external social media sites or social network services. Then, at 204 user profiles on each external social media site of the list may be compared to employee profiles in the internal corporate directory to determine a match (step 206) between internal and external identities. The match may be automatically determined at 206 by comparing publically available information contained in the internal and external user profile. For example, an individual may use the same username, photo or job description for both the corporate directory and his/her Facebook® account. In some embodiments, search capabilities of the external social media sites or social network services may be used to search for information about the user profiles, sorting the various possible users on the external social media sites and comparing them with the employee in question looking for a match.

Based on the type of information provided by the user (e.g. username, photo or job description) and whether this includes an exact match, the mapping may be made or merely given a certain confidence score. For example, in one embodiment, if the same photo is used by an employee in the company directory and on an external social media site, a match with 100% confidence may be determined. For example, in another embodiment, if a Twitter® user's name matches an employee's name exactly, a 75% confidence ranking may be given (because there could be individuals with the same name). It should be noted that mappings with confidence scores above a certain threshold may also be stored.

In some embodiments, the match between employees and external social media users at 206 may be achieved by, for example, comparing the I.P. address of a computer used to log in to an external social media account and the same computer being used to log in to an internal corporate account. The type of information posted by the given accounts may also be used to determine a match between internal and external accounts at 206, for example, if the same post (e.g. status message, link to news article, etc.) is made in both the external social media account and the internal corporate account within a given time window. Furthermore, profile matching may be based on a particular photo or video where an internal or external account is tagged in.

At 208 if the employee internal profile matches the external social media user profile, the mapping may be stored at 212. Optionally, a notification may be sent to the employee after identifying a match at 214. If the employee internal profile does not match the external social media profile, the search parameters may be adjusted at 210.

Embodiments of the present disclosure may provide a method, system and computer product to associate an employee internal record with an external record such that the two records may be linked; thereby providing additional insight into the entity associated with the records. For example, given a list of employees, this process may be used to determine matches between the employee and their external social media accounts, which then provides additional methods of communicating to the employee as well as monitoring of the employees information.

Therefore by using the described comparison program, a list of external social media sites may be generated from which users in each external social media site may be compared to employees in an enterprise directory to determine a match between at least one user in each external social media site and at least one employee in the enterprise directory and storing the mapping information. This may help monitoring employees' activity on external social media sites to prevent confidential data leaks and provide to an enterprise up-to-date information on employees point of view about topics of possible interest for the company.

Referring now to FIG. 3, a block diagram 300 of internal and external components of computers depicted in FIG. 1 is shown according to an embodiment of the present disclosure. It should be appreciated that FIG. 3 provides only an illustration of one implementation and does not imply any limitations with regard to the environments in which different embodiments may be implemented. Many modifications to the depicted environments may be made based on design and implementation requirements.

Data processing system 302, 304 is representative of any electronic device capable of executing machine-readable program instructions. Data processing system 302, 304 may be representative of a smart phone, a computer system, PDA, or other electronic devices. Examples of computing systems, environments, and/or configurations that may represented by data processing system 302, 304 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The server computer 114 (also referred to as network server) shown in FIG. 1 may include sets of internal components 302a and external components 304a illustrated in FIG. 3. The internal components 302a include one or more processors 320, one or more computer-readable RAMs 322 and one or more computer-readable ROMs 324 on one or more buses 326, and one or more operating systems 328 and one or more computer-readable tangible storage devices 330. The one or more operating systems 328, the Software Program 108 (FIG. 1) and the comparison program 116 (FIG. 1) in server computer 114 (FIG. 1) are stored on one or more of the respective computer-readable tangible storage devices 330 for execution by one or more of the respective processors 320 via one or more of the respective RAMs 322 (which typically include cache memory). In the embodiment illustrated in FIG. 3, each of the computer-readable tangible storage devices 330 is a magnetic disk storage device of an internal hard drive. Alternatively, each of the computer-readable tangible storage devices 330 is a semiconductor storage device such as ROM 324, EPROM, flash memory or any other computer-readable tangible storage device that can store a computer program and digital information.

The internal components 302a also includes a R/W drive or interface 332 to read from and write to one or more portable computer-readable tangible storage devices 338 such as a CD-ROM, DVD, memory stick, magnetic tape, magnetic disk, optical disk or semiconductor storage device. A software program, such as the Software Program 108 (FIG. 1), and the Comparison Program 116 (FIG. 1) can be stored on one or more of the respective portable computer-readable tangible storage devices 338, read via the respective R/W drive or interface 332 and loaded into the respective hard drive 330.

The internal components 302a also includes network adapters or interfaces 336 such as a TCP/IP adapter cards, wireless Wi-Fi interface cards, or 3G or 4G wireless interface cards or other wired or wireless communication links. The Software Program 108 (FIG. 1) and the Comparison Program 116 (FIG. 1) in server computer 114 (FIG. 1) can be downloaded to server computer 114 (FIG. 1) from an external computer via a network (for example, the Internet, a local area network or other, wide area network) and respective network adapters or interfaces 336. From the network adapters or interfaces 336, the Software Program 108 (FIG. 1) and the Comparison Program 116 (FIG. 1) in server computer 114 (FIG. 1) are loaded into the respective hard drive 330. The network may comprise copper wires, optical fibers, wireless transmission, routers, firewalls, switches, gateway computers and/or edge servers.

The external components 304a can include a computer display monitor 344, a keyboard 342, and a computer mouse 334. External components 304a can also include touch screens, virtual keyboards, touch pads, pointing devices, and other human interface devices. The internal components 302 also includes device drivers 340 to interface to computer display monitor 344, keyboard 342 and computer mouse 334. The device drivers 340, R/W drive or interface 332 and network adapter or interface 336 comprise hardware and software (stored in storage device 330 and/or ROM 324).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

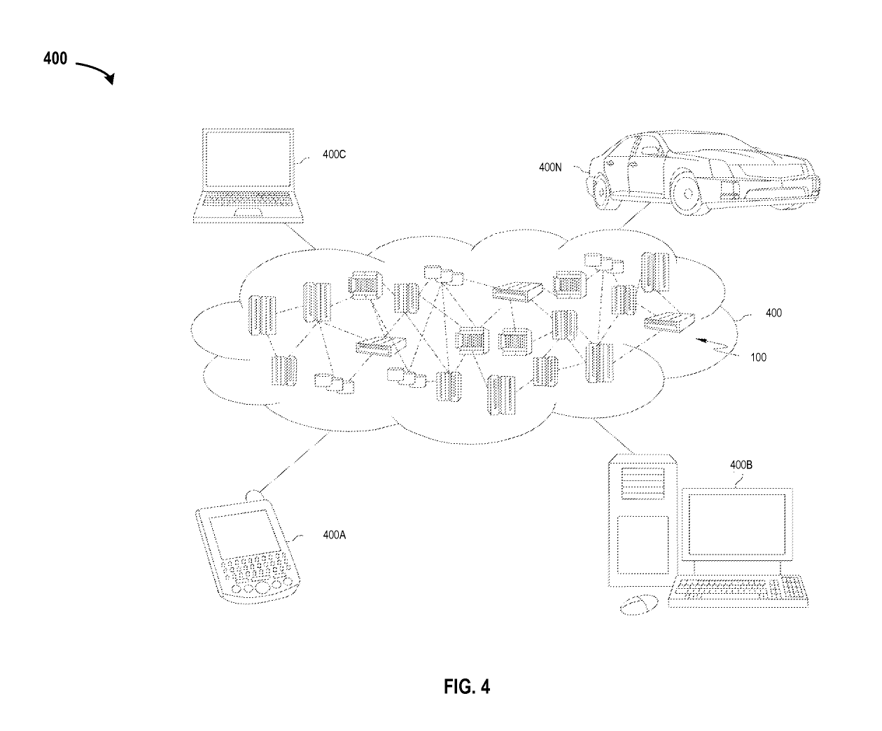

Referring now to FIG. 4, illustrative cloud computing environment 400 is depicted. As shown, cloud computing environment 400 comprises one or more cloud computing nodes 100 with which local computing devices used by cloud consumers, such as, for example, personal digital assistant (PDA) or cellular telephone 400A, desktop computer 400B, laptop computer 400C, and/or automobile computer system 400N may communicate. Cloud computing nodes 100 may communicate with one another. They may be grouped (not shown) physically or virtually, in one or more networks, such as Private, Community, Public, or Hybrid clouds as described hereinabove, or a combination thereof. This allows cloud computing environment 400 to offer infrastructure, platforms and/or software as services for which a cloud consumer does not need to maintain resources on a local computing device. It is understood that the types of computing devices 400A-N shown in FIG. 4 are intended to be illustrative only and that cloud computing nodes 100 and cloud computing environment 400 can communicate with any type of computerized device over any type of network and/or network addressable connection (e.g., using a web browser).

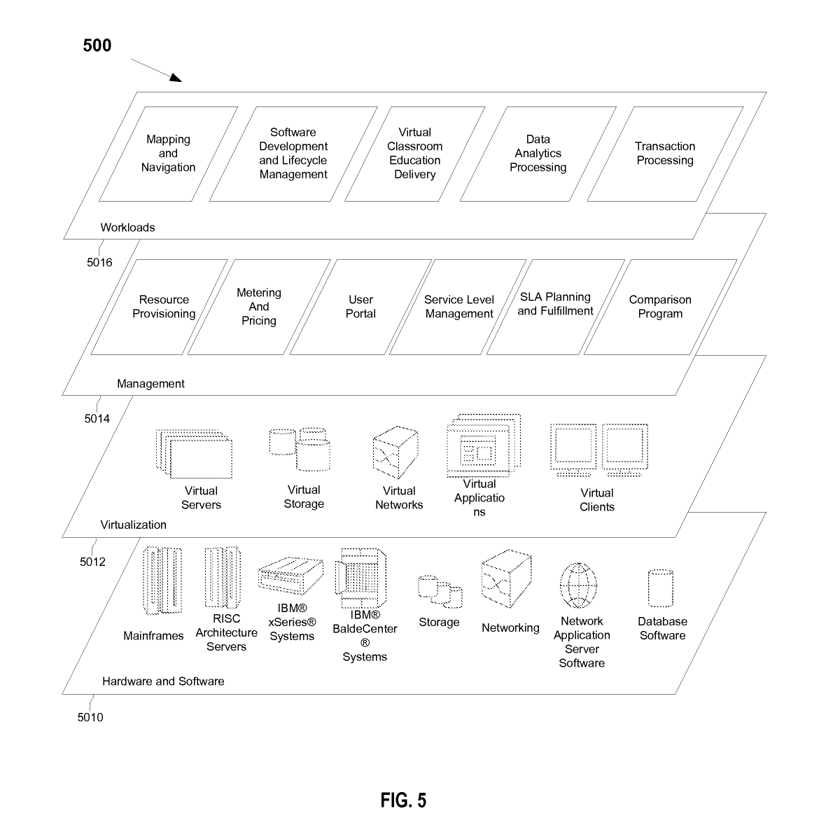

Referring now to FIG. 5, a set of functional abstraction layers 500 provided by cloud computing environment 400 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 5010 includes hardware and software components. Examples of hardware components include: mainframes; RISC (Reduced Instruction Set Computer) architecture based servers; storage devices; networks and networking components. In some embodiments, software components include network application server software.

Virtualization layer 5012 provides an abstraction layer from which the following examples of virtual entities may be provided: virtual servers; virtual storage; virtual networks, including virtual private networks; virtual applications and operating systems; and virtual clients.

In one example, management layer 5014 may provide the functions described below. Resource provisioning provides dynamic procurement of computing resources and other resources that are utilized to perform tasks within the cloud computing environment 400. Metering and Pricing provide cost tracking as resources are utilized within the cloud computing environment 400, and billing or invoicing for consumption of these resources. In one example, these resources may comprise application software licenses. Security provides identity verification for cloud consumers and tasks, as well as protection for data and other resources. User portal provides access to the cloud computing environment 400 for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA. A Comparison program 116 (FIG. 1) may identify employees on external social media.

Workloads layer 5016 provides examples of functionality for which the cloud computing environment 400 may be utilized. Examples of workloads and functions which may be provided from this layer include: mapping and navigation; software development and lifecycle management; virtual classroom education delivery; data analytics processing; and transaction processing.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for identifying employees across external social media sites, the method comprising:
generating a list of external social media sites to be compared with an employee profile associated with a corporate account of an enterprise employee listed in an enterprise directory, the external social media sites in the list being outside a corporate network where the enterprise directory is stored;
matching the employee profile associated with the corporate account to a social media user account associated with an external social media site in the list of external social media sites;
in response to matching the employee profile associated with the corporate account to the social media user account associated with the external social media site, automatically updating the enterprise directory by mapping the social media user account to the employee profile without an interaction from the enterprise employee, such that the enterprise directory is up-to-date regarding the enterprise employee activity in the external social media site: and
notifying the enterprise employee of the identified match between the employee profile associated with the corporate account and the user profile associated with the social media site.

2. (canceled)

3. The method of claim 1, further comprising:
storing the mapping between the social media user account and the employee profile.

4. The method of claim 1, wherein matching the employee profile associated with the corporate account to the social media user account associated with the external social media site comprises:
mapping a plurality of common information between the employee profile associated with the corporate account and the social media user account associated with the external social media site.

5. The method of claim 4, wherein the plurality of common information comprises a shared username, a photo, or a job description.

6. The method of claim 1, wherein matching the employee profile associated with the corporate account to the social media user account associated with the external social media site comprises:
comparing an I.P. address of a computer used to log in to the social media user account associated with the external social media site and the same computer being used to log in to the employee profile associated with the corporate account.

7. The method of claim 1, wherein matching the employee profile associated with the corporate account to the social media user account associated with the external social media site comprises:
identifying at least one similar post shared by the enterprise employee and the social media user.

8. The method of claim 1, wherein matching the employee profile associated with the corporate account to the social media user account associated with the external social media site comprises:
identifying at least one photo or at least one video where the enterprise employee and the social media user are tagged in.

9. A computer system for identifying employees across external social media sites, the computer system comprising:
one or more processors, one or more computer-readable memories, one or more
computer-readable tangible storage devices, and program instructions stored on at least one of the one or more storage devices for execution by at least one of the one or more processors via at least one of the one or more memories, wherein the computer system is capable of performing a method comprising:
generating a list of external social media sites to be compared with an employee profile associated with a corporate account of an enterprise employee listed in an enterprise directory, the external social media sites in the list being outside a corporate network where the enterprise directory is stored;
matching the employee profile associated with the corporate account to a social media user account associated with an external social media site in the list of external social media sites;
in response to matching the employee profile associated with the corporate account to the social media user account associated with the external social media site, automatically updating the enterprise directory by mapping the social media user account to the employee profile without an interaction from the enterprise employee, such that the enterprise directory is up-to-date regarding the enterprise employee activity in the external social media site; and
notifying the enterprise employee of the identified match between the employee profile associated with the corporate account and the user profile associated with the social media site.

10. (canceled)

11. The computer system of claim 9, further comprising:
storing the mapping between the social media user account and the employee profile.

12. The computer system of claim 9, wherein matching the employee profile associated with the corporate account to the social media user account associated with the external social media site comprises:
mapping a plurality of common information between the employee profile associated with the corporate account and the social media user account associated with the external social media site.

13. The computer system of claim 12, wherein the plurality of common information comprises a shared username, a photo, or a job description.

14. The computer system of claim 9, wherein matching the employee profile associated with the corporate account to the social media user account associated with the external social media site comprises:
comparing an I.P. address of a computer used to log in to the social media user account associated with the external social media site and the same computer being used to log in to the employee profile associated with the corporate account.

15. The computer system of claim 9, wherein matching the employee profile associated with the corporate account to the social media user account associated with the external social media site comprises:
identifying at least one similar post shared by the enterprise employee and the social media user.

16. The computer system of claim 9, wherein matching the employee profile associated with the corporate account to the social media user account associated with the external social media site comprises:
identifying at least one photo or at least one video where the enterprise employee and the social media user are tagged in.

17. A computer program product for identifying employees across external social media sites, the computer program product comprising:
a computer readable non-transitory article of manufacture tangibly embodying computer readable instructions which, when executed, cause a computer to carry out a method comprising:
generating a list of external social media sites to be compared with an employee profile associated with a corporate account of an enterprise employee listed in an enterprise directory, the external social media sites in the list being outside a corporate network where the enterprise directory is stored;
matching the employee profile associated with the corporate account to a social media user account associated with an external social media site in the list of external social media sites;
in response to matching the employee profile associated with the corporate account to the social media user account associated with the external social media site, automatically updating the enterprise directory by mapping the social media user account to the employee profile without an interaction from the enterprise employee, such that the enterprise directory is up-to-date regarding the enterprise employee activity in the external social media site; and
notifying the enterprise employee of the identified match between the employee profile associated with the corporate account and the user profile associated with the social media site.

18. (canceled)

19. The computer program of claim 17, further comprising:
storing the mapping between the social media user account and the employee profile.

20. The computer program of claim 17, wherein matching the employee profile associated with the corporate account to the social media user account associated with the external social media site comprises:
mapping a plurality of common information between the employee profile associated with the corporate account and the social media user account associated with the external social media site.
